(19) United States
(12) Patent Application Publication
(10) Pub. No.: US 2014/0200690 A1
(43) Pub. Date: Jul. 17, 2014

(54) METHOD AND APPARATUS TO MONITOR AND CONTROL CONDITIONS IN A NETWORK - INTEGRATED ENCLOSED ECOSYTEM FOR GROWING PLANTS

(71) Applicant: Amit Kumar, New York, NY (US)

(72) Inventor: Amit Kumar, New York, NY (US)

(21) Appl. No.: 14/157,468

(22) Filed: Jan. 16, 2014

Related U.S. Application Data
(60) Provisional application No. 61/753,238, filed on Jan. 16, 2013.

(51) Int. Cl. A01G 31/02

(52) U.S. Cl. CPC A01G 31/02
USPC 700/90

(57) ABSTRACT

A method and apparatus for monitoring and controlling a hydroponic system and its various electrical and environmental parameters through electronic interfaces in communication with third parties. Such electrical and environmental parameters can be determined by users through “grow plans ” to initiate, maintain, and/or cease particular environmental conditions corresponding to a user's preference.

This application claims priority to Provisional Application 61/753,238, filed on Jan. 16, 2013.

### BACKGROUND OF THE INVENTION

This invention relates generally to hydroponics and particularly to a method and apparatus used for monitoring and controlling various parameters associated with a hydroponic system through electronic interfaces in communication with third parties.

Hydroponic cultivation includes methods of growing plants using mineral environmental solutions, in water, without soil. Hydroponic cultivation has found favor with growers due to the increased yields and plant health compared to traditional plants grown in soil conditions. Plants are fed an environmental solution and are commonly kept in a controlled environment. While hydroponic cultivation has advantages over traditional plant growth techniques, it requires a more complex infrastructure to achieve satisfactory results.

Consumer interest in hydroponics gardening has substantially increased in recent years. The reasons for this probably include (1) some of the major countries of the world continuing to have problems producing food under typical conditions due to poor weather and/or poor soil in very populated areas, and (2) the availability of land for gardens for the average homeowner is rapidly decreasing. Hydroponic gardening techniques offer the possibility of home-grown food products to the townhouse apartment owner, or the owner of a small home with little land who cannot otherwise have a garden.

A particular problem plaguing consumer-based hydroponics gardening has been remote monitoring and control of conditions when a user is away from his/her plants. Because hydroponic cultivation is particularly sensitive to changes in system conditions, immediate action is often needed which consumers have difficulty meeting due to scheduling restraints.

There is a need for techniques to effectively monitor and control conditions in a hydroponic garden by users away from the location of the garden.

### SUMMARY OF INVENTION

The present invention improves previous methods for hydroponic cultivation in several ways. Firstly, the invention monitors all the environmental and system parameters and communicates with both a host server and user to ensure conditions are being constantly monitored and adjusted. Secondly, the invention facilitates controlling electrical devices both on fixed schedules and in response to measured changes in environmental and electrical parameters indicated by a user. Thirdly, the invention facilitates allowing a user to remotely access, control, and monitor the hydroponic system through a user interface, accessible from any network connection. Fourthly, the invention facilitates automatically notifying the user when any parameters experience significant change in preferred values. Lastly, user-input values pertaining to environmental parameters can be compiled into “grow plans”, which serve to optimize growth conditions given certain environmental conditions and subsequent adjustments made by the hydroponics ecosystems. A phase is a building block unit in constructing a “grow plan”, used to initiate, maintain, and/or cease particular environmental parameters corresponding to a user's preference. For example, a “seedling stage” phase of a “grow plan” may be programmed for particular lighting conditions, temperature, and humidity. A new phase can be initiated upon the fulfillment of certain pre-programmed conditions (e.g. ideal range violation), which may initiate a subsequent phase of the “grow plan”, which may be suitable for a different stage in a plant's lifecycle. It should be noted that a phase is deemed “active” only during an instance of a “grow plan” being initiated and active.

Users can monitor data to determine optimal conditions for phases in a particular “grow plans”. These “grow plans” can include data obtained from other users over the World Wide Web or remote servers. By virtue of being connected to other networked computer system, users can also give permission to upload “grow plans” onto remote servers to allow other users to download and implement “grow plans” on their individual hydroponics ecosystems. In one embodiment of the present invention, a user can search a database of user-generated “grow plans” based on popularity, particular seeds, and/or ease of maintenance. In another embodiment, a user can interact with other users in troubleshooting implementation of a “grow plan”.

This creation, management, and sharing of “grow plans” is a significant distinguishing factor of the present invention over prior art. This feature of the present invention enables greater user collaboration and precision in achieving successful and replicable results for a wide variety of hydroponic ecosystems. A branching methodology enables users to create derivative “grow plans,” allowing a family of “grow plans” to branch out from an original parent. The quality of such “grow plans' is maintained through self-sustaining open-source techniques embodied in transparent community governance and testing standards. Such open-source techniques include standardization of online community voting, moderators overseeing incorporation of advantageous derivative “grow plan” parameters into parent “grow plans”, and illustrating the relationships of “grow plans” for users to further create and collaborate on.

The invention achieves all these capabilities while retaining a physically small form factor, and is easily integrated into the hydroponic installation in a manner similar to the existing art.

In a preferred embodiment, the invention uses an array of sensors to measure environmental parameters and conditions such as air temperature, water temperature, relative humidity, CO₂ concentration, O₂ concentration, pH levels, ammonia levels, nitrite and nitrate concentrations, and airflow. It also has general-purpose electrical inputs to measure sensors such as liquid-level float switches, water depth sensor, security sensors, fan tachometer, and any other sensing device which can produce a low-voltage digital or analog output signal. To operate electrical equipment such as lamps, pumps, fans, blowers, or environmental dosers, the invention includes multiple electrical relays which can each switch standard AC mains voltage. The invention further senses the amount of power consumed by the attached electrical equipment, and keeps a running total of electrical energy used. Present and historical measurements and control activity are stored in the internal memory of the present invention, or external memory connected to an expansion port commonly used with personal computers. This data can be further analyzed by the operator to detect trends throughout the growing season.

In another preferred embodiment, the array of sensors used to measure environmental parameters can be calibrated with the water reservoir system and nutrient supply chains within the hydroponics system to maintain user-input values pertaining to at least one of the parameters.

In another preferred embodiment, the user interface is a standard World-Wide-Web Browser (web browser), of the kind typically found on personal computers for browsing the Internet. To accomplish this, the invention contains a network interface device which is connected to the operators' local area network (LAN) using wireless technology. As such, the user-interface for the present invention appears as just another Internet web-site, which is accessible via said web browser. All configuration, status information, and present and historical measurements of system parameters are available through the web browser, using multiple web pages, connected together to form a comprehensive web site. This allows for an interface between the operator and the invention, complete with text, graphics, and multimedia content. As an example of the utility provided by this type of interface, the invention may provide a frequently updated graph of pH, environmental concentration (EC), temperature, relative humidity, light intensity, and AC power consumption over the past 24 hours or 7 days. Preferred ranges are highlighted in specific colors, while any measurements outside of the preferred range are clearly identified in another color or pattern. The user can quickly see trends among the different parameters. Another web page may be used to configure the fixed schedule for electrical devices which are operated on timers. Various timer schedules can be set and viewed. Timer schedules and past activity may be displayed in a bar-graph along a time-axis, with different colors for each device. Similar intuitive web pages may be used for any of the other functions provided by the invention. This web browser interface greatly simplifies the task of configuring the invention for the demands of a particular hydroponic installation.

In another embodiment, if the LAN has connectivity to the Internet, as is typical in many homes and commercial buildings, the present invention can be configured to be accessible from anywhere on the Internet. No longer does the user have to be on-site to check the status of their hydroponic system parameters, or operate electrical equipment or control various system devices. In this case, all monitoring and control is accessible via the Internet and a web browser from potentially anywhere in the world. This ability to connect to wireless networks further simplifies integration of the present invention in a greenhouse or garden environment, where wired network cabling may not be available or desired.

In another preferred embodiment, once network connectivity has been established, the invention provides many benefits that do not exist with the prior art. Remote control and monitoring has been described. Remote notification is also possible. The operator can configure the device to notify him or her of the existence of any undesired conditions, such as environmental concentration too low, or temperature too high, or a low light level due to a faulty lamp. Surely, one skilled in the art can conceive of other conditions in the hydroponic installation which would merit notification of the operator. The notification takes the form of electronic mail, Short Message Service (SMS) text page, or Multimedia Messaging Service (MMS) message. These notifications can be retrieved by the operator through typical means such as using an email client program, checking an Internet web site, or using a cell phone which can receive SMS or MMS messages or email. If the operator chooses to be notified by SMS message to a cell phone, they can be notified in real-time or near-real-time of any conditions in the hydroponic installation that warrant their immediate attention. This capability allows the operator to respond promptly to remedy a situation which might otherwise cause plant harm or financial loss. Prior art hydroponic and greenhouse controllers lack this important distinguishing feature.

In another preferred embodiment, the present invention also has the ability to query Internet time servers to ensure that the internal clock is always correct, including changes due to daylight savings time (DST), and any time errors which might occur due to a power outage in the hydroponic installation.

In another embodiment, electronic mail can also be used to send the previously recorded measurement data on internal or external memory to the operator's email account. This provides another way to archive measurement data which can then be further integrated into a data analysis or tracking system.

Additional embodiments include capabilities pertaining to online access of information. For example, an Internet web site or service can be checked by the apparatus, periodically, to retrieve the latest weather forecasts. These forecasts can be used to alter the control of equipment to allow the plants to respond better to environmental conditions. An earlier example was cited, where environmental flow might be adjusted in anticipation of heavy rain, or environmental composition might be altered to better respond to hot conditions which would otherwise stress the plants.

In another embodiment, to complement the sensors which measure environmental and hydroponic system parameters, the invention supports external cameras, also known as webcams, to capture digital still images and digital video, with or without audio, and transmit it to a computer. The present invention uses the camera(s) to take snapshots of the plants or other parts of the hydroponic installation at fixed intervals, or in response to the operator's request via the web site. This provides visual feedback to the operator of conditions in the installation, complementing the information from other sensors. Periodic snapshots can be combined together over the course of the growing season to create a time-lapse motion picture of the plant growth over time. Optionally, the system parameters can be added as text or graphics overlay on each of the camera images to show correlation between system parameters and actual plant growth and response. Such a feature gives the operator a clear, intuitive understanding of how the plant responds to its environment. Time-lapse motion pictures illustrate subtleties which can be missed by examining plant physiology on a daily basis, since changes may occur very slowly. Examining such time-lapse evidence could enable the operator to further optimize their resource usage, and hence increase profitability. This can provide visual feedback to the operator of dynamic conditions at the hydroponic installation, such as the effects of air movement, changing light, or running water.

For all the reasons stated, it will become clear to someone skilled in the art, that the present invention offers a variety of benefits that are not currently available, with the technology of the prior art. These include direct benefits to the grower, including optimized plant growth, resource efficiency, reduced effort, and nearly immediate knowledge of conditions which may harm plant health and reduce yields.

### BRIEF DESCRIPTION OF THE DRAWINGS

FIG. 1 is a distributed network system according to one embodiment of the invention.

FIG. 2 is a flow diagram illustrating a method according to one embodiment of the invention, as depicted in FIG. 1;

FIG. 3 is a schematic diagram according to one embodiment of the invention;

While the invention is described with reference to the above drawings, the drawings are intended to be illustrative, and the invention contemplates other embodiments within the spirit of the invention.

### DETAILED DESCRIPTION OF THE DRAWINGS

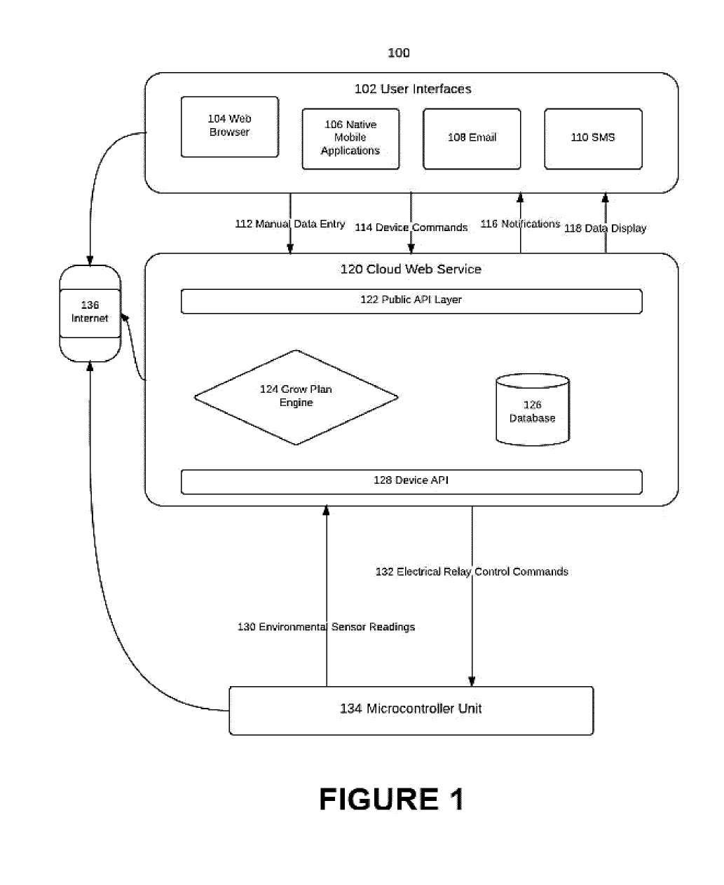

FIG. 1 is a distributed network system 100 according to one embodiment of the invention. The system 100 includes user interfaces 102, a cloud web service 120, and a microcontroller unit 134, all coupled or able to be coupled to the Internet 136. Although the Internet 136 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

The user interfaces 102 and microcontroller unit 134 may be distributed, and can include various hardware, software, applications, algorithms, programs and tools. Depicted hardware may also include a hard drive, monitor, keyboard, pointing or selecting device, etc. The hardware may operate using an operating system such as Windows by Microsoft, etc. Each piece of hardware may include a central processing unit (CPU), data storage device, and various amounts of memory including RAM and ROM. Depicted devices may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

The user interfaces 102 are comprised of at least a web browser 104, native mobile applications 106, email 108, and SMS messages 110. As provided by user interfaces 102, a cloud web service 120 receives this information via manual data entry 112 and/or device commands 114. A grow plan engine 124 corresponding database 126 are utilized in generating, maintaining, and storing information pertaining to grow plans as specified by a user. The user interfaces interacts with the cloud web service 120 via a public application programming interface (API) layer 122. The cloud web service is further coupled to a microcontroller unit 134. In some embodiments, this comprises the hydroponic ecosystem apparatus. The microcontroller unit 134 receives electrical relay control commands 132 via the device API 128 as determined by the grow plan engine 124 and corresponding database 126. Environmental sensor readings 130 from the microcontroller unit 134 are relayed back to the cloud web service 120, which in turn is relayed back to the user interfaces 102, via notifications 116 and/or a data display 118.

The grow plan engine 124 is intended to broadly include all programming, applications, algorithms, software and other and tools necessary to implement or facilitate methods according to embodiments of the invention. The elements of the grow plan engine may exist on a single server computer or be distributed among multiple computers or devices

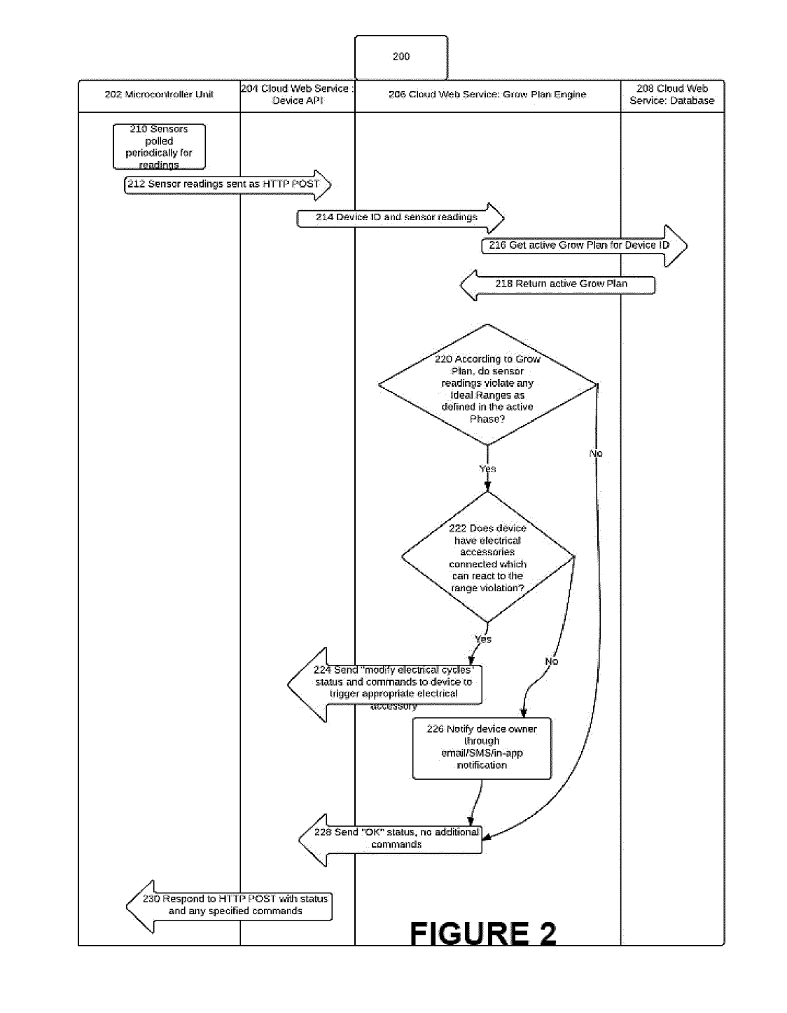

FIG. 2 is a flow diagram of a method 200 according to one embodiment of the invention. as depicted in FIG. 1. The diagram depicts distinct hardware, software, and/or devices as part of the method 200: a microcontroller unit 202, which in some embodiments is a hydroponics ecosystem apparatus; a cloud web service device API 204; a cloud web service grow plan 206; and a cloud web service 208.

At step 210, using one or more computers, sensors are polled periodically for readings according to user programmed parameters. At step 212, using one or more computers, these sensor readings are sent to the device API 204 in Hypertext Transfer Protocol (HTTP) POST format. At step 214, using one or more computers, the device ID and sensor readings are relayed to the grow plan engine 206. At step 216, using one or more computers, the grow plan engine 206 sends an active “grow plan” for the device ID to the cloud web service database 208. At step 218, using one or more computers, the database 208 returns an active grow plan to the grow plan engine 206. At step 220, using one or more computers, an algorithm is implemented using the active grow plan sent by the database 208 to the grow plan engine 206. The algorithm first determines if, according grow plan, the sensor readings violate any user-created ideal ranges defined in a phase as specified in an active grow plan. If negative, at step 228, using one or more computers, the grow plan engine 206 sends an “OK” status with no additional comments to the device API 204. If affirmative, at step 222, using one or more computers, the algorithm determines if the device has electrical accessories connected to it which can react to any ideal range violations. If negative, at step 226, using one or more computers, the device owner is notified through email, SMS messaging, or in-app notification of no such violation before proceeding to step 228. If affirmative, at step 224, using one or more computers, a “modify electrical cycles” status and commands are sent to the device via the device API 204 to trigger an appropriate electrical accessory. Lastly, at step 230, using one or more computers, the device API 204 responds to the HTTP POST with a status and any specified commands to the microprocessor unit 202.

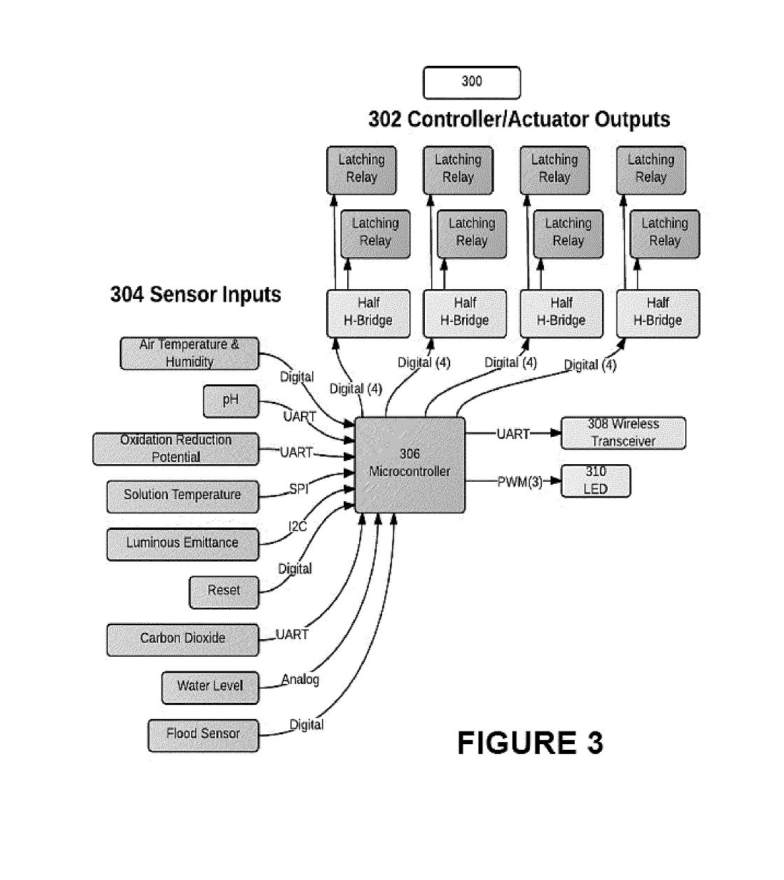

FIG. 3 is a schematic diagram according to one embodiment of the invention. A microcontroller unit 306 is coupled to at least controller/actuator outputs 302, sensor inputs 304, a wireless transceiver 308, and a light-emitting diode (LED) 310. The sensor inputs 304 are comprised of parameters to be constantly monitored and, if possible, maintained at user-defined levels or according to grow plan specifications. These parameters include air temperature and humidity, pH, oxidation reduction potential, solution temperature, luminous emittance, water level, and carbon dioxide. The air temperature and humidity sensor is coupled to the microcontroller 306 following a digital communication protocol. The pH, oxidation reduction potential, and carbon dioxide reduction potential sensors, respectively, are coupled to the microcontroller 306 following a universal asynchronous receiver/transmitter (UART) communication protocol. The luminous emittance sensor is coupled to the microcontroller 306 following an inter IC (I2C) communication protocol. The solution temperature sensor is coupled to the microcontroller 306 following a serial peripheral interface bus (SPI) communication protocol. The water level is monitored by the microcontroller 306 following an analog communication protocol. A reset and flood sensor input are also coupled to the microcontroller 306 via a digital connection. The controller/actuator outputs 302 are comprised of at least four outputs coupled to the microcontroller 306 following digital communication protocols. Each controller/actuator is composed of a half H-bridge coupled to latching relays. The microcontroller 306 is further coupled to a wireless transceiver 308 via a UART communication protocol and an LED via at least three pulse width modulation (PWM) connections.

We claim:

1. A method for monitoring and controlling an enclosed ecosystem for growing plants, the method comprising a means of measuring and controlling one or more values for at least one environmental parameter comprising airflow, oxygen concentration, carbon dioxide concentration, nitrate concentration, nitrite concentration, pH levels, humidity, ammonia level, nutrient solution level, oxidation reduction potential, conductivity, air temperature, and water temperature; a means of measuring and controlling the values of at least one electrical parameter associated with one or more electrical devices comprising actuators, valves, light intensity, or pump volumes by means of switching a source of electrical power on and off; a means of connecting to a computer data network and transferring data over the network to and from one or more computer systems; and a means of providing a user interface accessible via a world-wide-web browser software program communicating over the computer data network.

2. The method of claim 1, further comprising a means of connecting one or more digital cameras to the one or more electrical devices the user interface.

3. The method of claim 1, further comprising a means of measuring the amount of electrical power consumed by the one or more electrical devices.

4. The method of claim 1, wherein the electrical devices are peripheral light meters.

5. The method of claim 1, wherein the at least one environmental parameter is determined by data obtained from the computer data network.

6. The method of claim 1, wherein the means of connecting to the computer data network is using a wireless method.

7. The method of claim 1, further comprising a means of allowing a user to observe the previously measured values of the electrical and environmental parameters via said user interface; and a means of allowing the user to direct the control of the electrical devices via said user interface.

8. The method of claim 1, further comprising a means to communicate to a user a change in electrical and environmental parameters.

9. The method of claim 8, wherein the means to communicate is by electronic mail.

10. The method of claim 8, wherein the means to communicate is programmable by the user.

11. The method of claim 1, wherein the means of maintaining the values of the electrical and environmental parameters is specified as part of a grow plan for optimal growth.

12. The method of claim 11, wherein the grow plan is comprised of at least a phase defined by a user, wherein a phase comprises at least phase parameters comprising a duration of time, description of goals, discreet actions, and ideal ranges for environmental and lighting conditions.

13. The method of claim 11, wherein the grow plan activates at least a phase triggered by predetermined values of the electrical and environmental parameters.

14. The method of claim 11, wherein the grow plan is obtained from the computer data network.

15. The method of claim 11, wherein the software program is hosted on a remote server.

16. An apparatus for monitoring and controlling a hydroponic system, comprising a moisture resistant enclosure; a rubber lining around the enclosure to create an air tight seal; a water reservoir system; a wireless modem to a computer data network and transferring data over the network to and from other computer systems; and a user interface accessible via a world-wide-web browser software program communicating over the computer data network.

17. The apparatus of claim 16, further comprising at least one light emitting diode component.

18. The apparatus of claim 16, wherein the moisture resistant enclosure is comprised of translucent acrylic.

19. The apparatus of claim 16, wherein the software program is hosted on a remote server.
